(19) United States
(12) Patent Application Publication
(10) Pub. No.: US 2007/0137128 A1
(43) Pub. Date: Jun. 21, 2007

(54) Modular stone panel

(76) Inventors: Nicolas Viau, Dorval (CA); Richard Viau, Dorval (CA); Pierre Duquette, Sainte-Clothilde (CA); Gabriel Dragomir, Montreal (CA)

Correspondence Address: BCF LLP, 1100 RENE'-LE'VESQUE BLVD. WEST, 25TH FLOOR, MONTREAL, QC, H3B-5C9, CA

(21) Appl. No.: 11/444,539

(22) Filed: Jun. 1, 2006

Related U.S. Application Data
(60) Provisional application No. 60/741,461, filed on Dec. 2, 2005.

(51) Int. Cl. E04F 13/08; B44F 7/00; B44F 9/04; B32B 37/00; E04B 2/00; E04C 1/00; B29C 65/00

(52) U.S. Cl. 52/388; 52/315; 52/385; 52/781; 156/299

(57) ABSTRACT

A modular stone panel is disclosed. The panel is adapted to be mounted or fastened to a structural wall to provide a stone wall facade therefor. The panel is generally comprised of a shaped backboard and a plurality of stones solidly fastened on a front face thereof. The backboard is adapted to be fastened to the structural wall such that the front face thereof faces away from the wall to provide the stone wall facade. The stones may comprise natural or synthetic molded stones. The backboard may also be ventilated to provide ventilation to the stones fastened thereto. The panels may be fabricated to provide key-cut edges allowing an interlocking of adjacent panels. A method of fabricating such panels is also disclosed.

### CROSS REFERENCE TO RELATED APPLICATIONS

This application claims priority on U.S. Provisional patent application No. 60/741,461 filed on Dec. 2, 2005, and is herein incorporated by reference.

### FIELD OF THE INVENTION

The present invention relates to modular stone panels and, more specifically, to a fabrication and assembly thereof for the construction of stone wall structures and the like.

### BACKGROUND OF THE INVENTION

A number of interior and exterior wall constructions and aesthetic claddings and facades are commonly used in home, commercial and industrial installations to provide various visual and textural effects and finishes. Such constructions can include bricks, stones, molded cementitious blocks and the like generally mounted one by one by a mason or stoneworker to form a solid wall structure.

However, these techniques are generally labor intensive and, particularly when using natural stone products, can be relatively costly and require significant expertise for proper installation.

### SUMMARY OF THE INVENTION

In order to address the above and other drawbacks of known techniques, it is an aim of the present invention to provide modular stone panels for the construction of stone wall structures and the like.

More specifically, in accordance with the present invention, there is provided a modular stone panel for fastening to a wall to provide a stone wall facade therefor, the panel comprising a shaped backboard and a plurality of stones solidly fastened on a front face thereof, the backboard being adapted to be fastened to the wall such that the front face faces away therefrom to provide the stone wall facade.

Also in accordance with the present invention, there is provided a method of fabricating a modular stone panel, the method comprising the steps of:
a) providing a shaped backboard and a plurality of stones; and
b) fastening said stones to said backboard;
   wherein the backboard is adapted to be fastened to a wall to provide a stone wall facade therefor.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is an exploded perspective view of a modular stone panel in accordance with a first illustrative embodiment of the present invention;

FIG. 2 is a perspective view of a panel section used in the fabrication of the modular stone panel of FIG. 1;

FIG. 3 is an exploded perspective view of an installation of two vertically adjacent modular stone panels, wherein the stones or blocks thereof are not shown so as to clarify the illustration, on a solid wall structure fitted with cooperative fastenings in accordance with the illustrative embodiment of FIG. 1;

FIG. 4 is a cross-section of the vertically adjacent modular stone panels of FIG. 3 along line 4-4 thereof, illustrating a number of stones fastened thereto and illustrating in greater detail the installation thereof to the solid wall structure;

FIG. 5 is a diagrammatic top side view of an arcuate wall comprised of rounded modular stone panels in accordance with a second illustrative embodiment of the present invention;

FIG. 6 is an exploded perspective view of modular stone panel in accordance with a third illustrative embodiment of the present invention;

FIG. 7 is an exploded perspective view of a modular stone panel mounted to a solid wall structure in accordance with a fourth illustrative embodiment of the present invention; and

FIG. 8 is an exploded perspective view of a modular stone panel mounted to a solid wall structure in accordance with a fifth illustrative embodiment of the present invention.

### DESCRIPTION OF ILLUSTRATIVE EMBODIMENTS

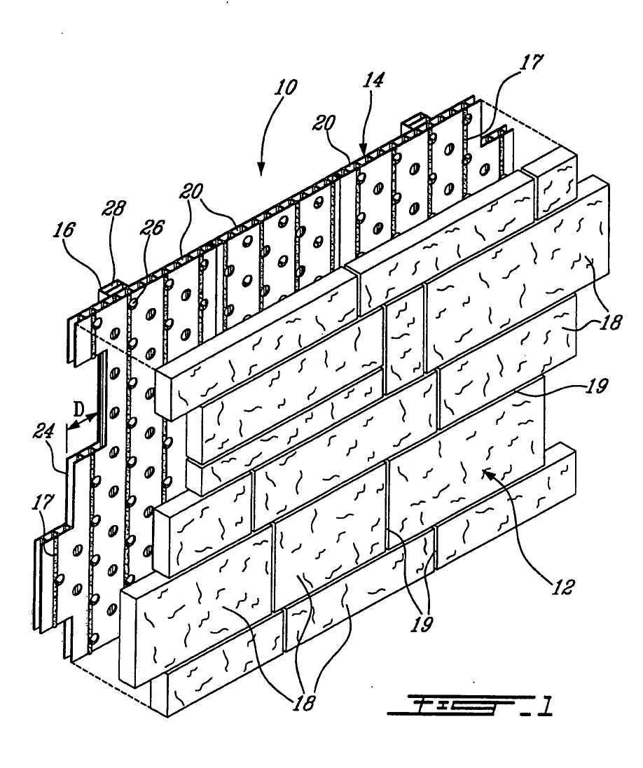

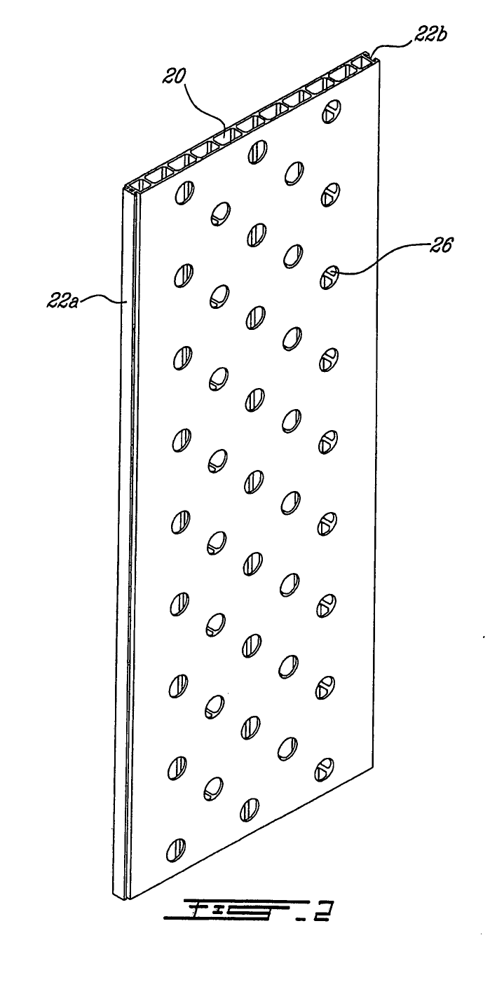

Referring now to FIGS. 1 and 2, in accordance with a first illustrative embodiment of the present invention, a modular stone panel, generally referred to using the numeral 10 and configured to be used as a facade or cladding in exterior and interior wall constructions to provide the appearance of a stone wall, will now be described. The modular stone panel 10 is generally comprised of a stone face 12 solidly mounted on the front face of a backboard or the like 14, itself fitted with a set of mounting brackets 16 on a back face thereof.

In particular, the stone face 12 is comprised of a series of thin and alternatively shaped stones or blocks, as in 18. These stones or blocks 18 may be selected from a variety of products ranging in shape, texture, color and/or weight to produce, when combined in any number of configurations, a variety of visual, textural and structural effects. Namely, the blocks 18 are illustratively comprised of ¾ inch thick rocks, though rock thicknesses ranging from roughly ¼ inch to 2 inches may also be considered, selected from a number of natural stone products including, but not limited to, granite and calcareous rock varieties such as Desert Buff, Chablis, Chablis Perigord, Indiana, Citadelle, St-Mark, Toscan and the like. These rocks 18 are generally prepared to present a smooth back surface to be glued or mounted to the backboard 14 and a smooth or textured (rockface) front surface selected in accordance with a desired look or panel finish.

A person of skill in the art will understand that a other rock varieties as well as other types of natural stone products and finishes can be considered in the present context without extending the general scope and nature of the present disclosure. In addition, other types of stones or blocks 18 may be selected to provide similar results. For instance, the modular stone panel 10 may be fabricated using a number of synthetic stone products such as molded cement and concrete blocks, as well as blocks molded from stone dust recuperated from various stone cutting and shaping processes. Also, though the following illustrative embodiments present stone panels fabricated using various square and/or rectangular stone products, it is to be understood that any type, size or shape of natural or synthetic stone product may be used interchangeably and/or in combination to provide a variety of stone panel products in accordance with the present invention.

In the present embodiment, the stones or blocks 18 may be randomly or cyclically mounted to the backboard 14 using various glues or epoxies 17 which may include, but are not limited to, A & B epoxies and Stonemate silicones. The glues and/or epoxies 17 may be selected based on a number of physical properties suggested for the finished product. Namely, exterior panels may require glues that offer greater resistance to temperature and weather variations than required for interior panels. Also, glue and epoxy curing times may vary based on the specific methods employed to fabricate the panels. In addition, selection of appropriate glues and/or epoxies could vary according to the stone product and backboard materials used for a given panel. A person of skill in the art will understand that various glue selections, as well as various glue application and distribution patterns may be considered in the present context without departing from the general scope and nature of the present disclosure.

Once the stones 18 are securely fastened to the backboard 14, a joint compound, which may include mortars, silicones, polyurethanes, acrylics and any combination thereof, may be added in the joints 19 between the blocks 18 to provide a selected wall finish to the panel 10. Alternatively, the mortar may only be added once the panels 10 are assembled on site such that mortar used to bridge joints between panels 10 may better match the mortar used to bridge joints between the blocks 18 of a given panel 10.

With reference to FIGS. 1-3, the backboard 14 is illustratively comprised of three backboard sections, as in 20, cooperatively coupled to provide a desired panel shape. In particular, the sections 20 may be comprised of cooperative opposed lateral edges 22a and 22b (FIG. 2) adapted to be mated with the corresponding lateral edges 22b and 22a, respectively, of adjacent sections 20. Other types, configurations and sequences of cooperative lateral edges, as in 22a and 22b, may also be considered to join adjacent panel sections. Alternatively, sections 20 may be coupled indirectly using appropriately mated couplers, fasteners and the like (not shown), or again, the backboard 14 may be comprised of a single piece shaped to provide the desired panel shape.

In this embodiment, the three-piece backboard 14 is shaped to provide a panel 10 presenting cooperative key-cut edges 24 such that a succession of laterally adjacent panels 10 may be interlocked to provide a virtually seamless juncture between such panels 10. In particular, the depth D of the key cut edges 24 may vary, illustratively from roughly 1 to 4 inches, to adjust the interlocking of adjacent panels 10. Alternatively, as should be apparent to a person of skill in the art, similar key-cut edges may be provided on the upper and lower edges of the panels to further mask horizontal junctures between the panels 10. Other cooperative edge shapes, sizes, depths and profiles, which may include key-cut profiles, straight or square edges, as well as various formed edges, should also be apparent to the person of skill in the art.

Still referring to FIGS. 1-3, the backboard 14 is further comprised of a number of perforated ventilation holes or openings 26 provided to increase a ventilation of the stones 18 mounted on the backboard 14 to reduce an accumulation of moisture and humidity in the panel 10 and thereby increase their durability and weatherability. Such ventilation is illustratively provided in the present embodiment by a number of circular holes of roughly ¾ inch diameter corresponding to a ventilation area of approximately 10% of the backboard's surface. As will be described further hereinbelow with reference to other illustrative embodiments of the present invention, ventilation techniques may be varied to provide ventilation areas ranging from 0% to roughly 95% of the panel's supporting backboard 14.

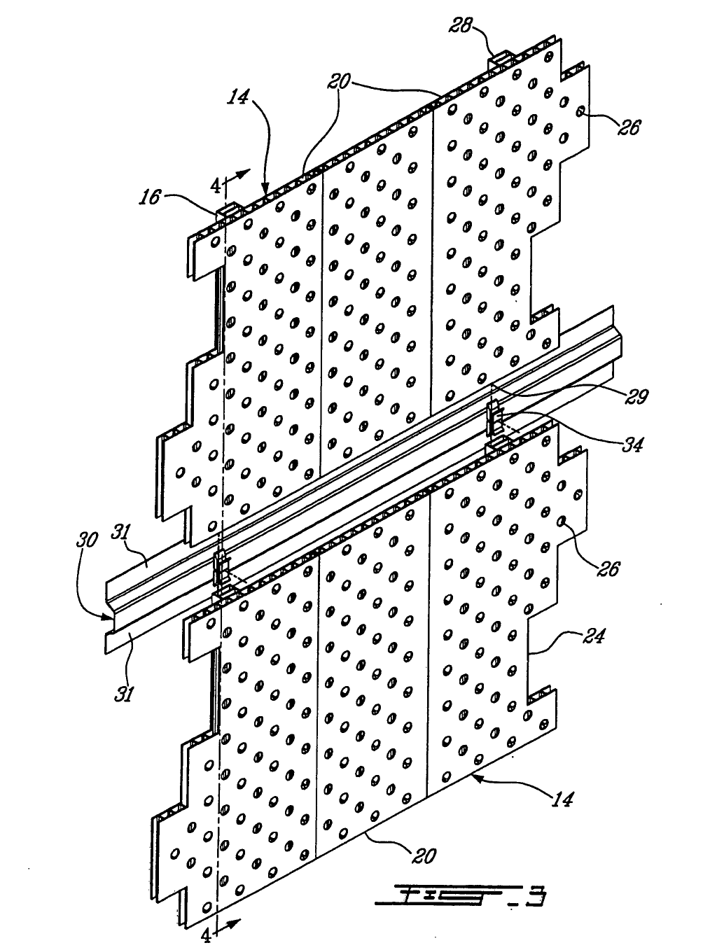

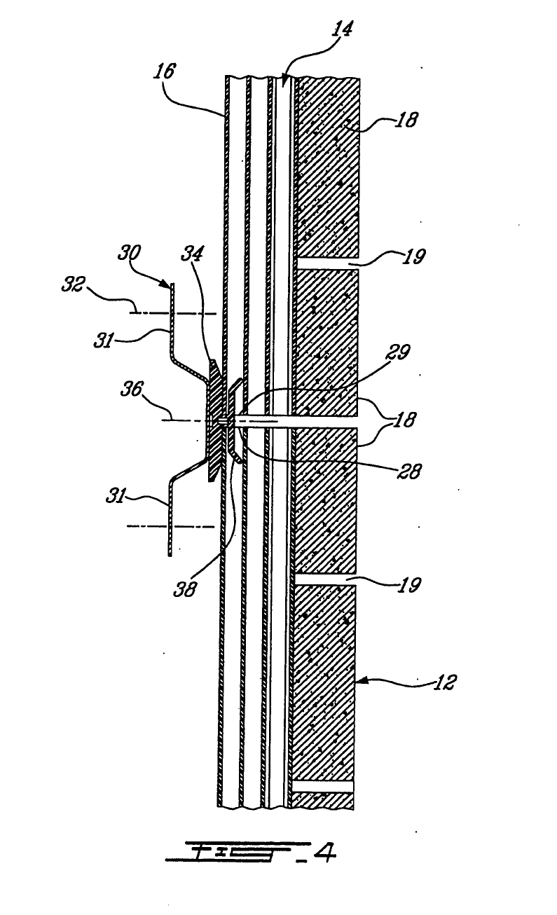

Referring now to FIGS. 3 and 4, the panel 10 is fitted with a number of mounting brackets 16 securely fastened to the back face of the backboard 14. For example, these brackets may include metal or plastic structures mounted vertically on the backboard 14 to provide upper and lower wall-engaging ends 28, 29 for the installation of the panel 10 to a solid wall structure, namely to a metal omega-shaped transversal support beam 30 (FIG. 3) solidly mounted to a structural wall or the like (not shown). In particular, the present embodiment allows the illustrative panels 10 to be mounted to a structural wall via the support beams 30 while maintaining a panel-to-wall distance of roughly ⅞ of an inch, thereby allowing for sufficient ventilation of the stones or blocks 18 through the holes or openings 26. A person of skill in the art will understand that the panel-to-wall distance may be varied, namely from roughly ¼ inch to 3 inches depending on the desired ventilation properties of the mounted panels 10, by using similar or alternative mounting techniques. For instance, other types and shapes of mounting brackets may be considered and should become apparent to a person of skill in the art upon reference to the following examples. Also, the panels 10 may be directly mounted to the wall supporting studs or other such structural wall components without extending the scope of the present disclosure.

In the present embodiment, the support beams 30 are securely fastened to the wall's structural supporting studs or other such wall structural supports (not shown) using a number of fastening means such as nails, screws and the like 32. A number of H-shaped brackets or fastenings 34 are fastened to the beams 30, again using standard or optimized fastening means such as nails, screws, bolts and the like 36, to provide wall-anchoring means for the panels 10. Illustratively, the wall-engaging ends 28, 29 of the panel's mounting brackets 16 are adapted to engage the outer legs 38 of the H-shaped brackets 34. As such, successive rows of panels 10 may be mounted vertically atop one another using successive support beams 30 and corresponding brackets 34. As presented hereinabove, mortar may be applied between adjacent panels to conceal the panel junctures.

In general, panels as in 10 may be prefabricated for eventual shipment to a construction site for installation. An exemplary fabrication of a panel 10 may include the following steps.

A stone product is first selected based on desired style, finish and estimated project costs. The backboard 14 is assembled in a desired panel shape (key-cut, rectangular, etc.) and fitted with the mounting brackets 16. The selected stone product is then positioned on the backboard; a template may be used to verify and adjust the shape and positioning of the stone products on the backboard 14. Stones or blocks 18 needing adjustment are marked and carefully shaped using a saw or other such stoneworking tools or machinery.

When each selected stone or block 18 is ready, they are removed from the backboard 14 for cleaning. Generally, the backboard 14 is wiped down to reduce the presence of grease and/or residual dust that could hinder adhesion of the rocks 18 to the backboard 14. The rocks themselves may also be washed using, for instance, a methyl hydrate product.

Once all surfaces are clean, the rocks 18 are glued to the backboard 14 using an appropriate glue or epoxy, generally leaving straight joints 19 (roughly ¼ inch) between the rocks 18 for the later application of a mortar to complete the finished stone face 12. The dry finished panels 10 may then be stacked and packaged in crates to be shipped to a construction site for installation.

A person of skill in the art will understand that wider or narrower joints 19 may also be considered in the above example to provide a variety of visual and textural finishes to the panels 10. Alternatively, the rocks 18 may be stacked tightly without joints 19, thereby avoiding the use of mortar and providing yet another look to the panels 10.

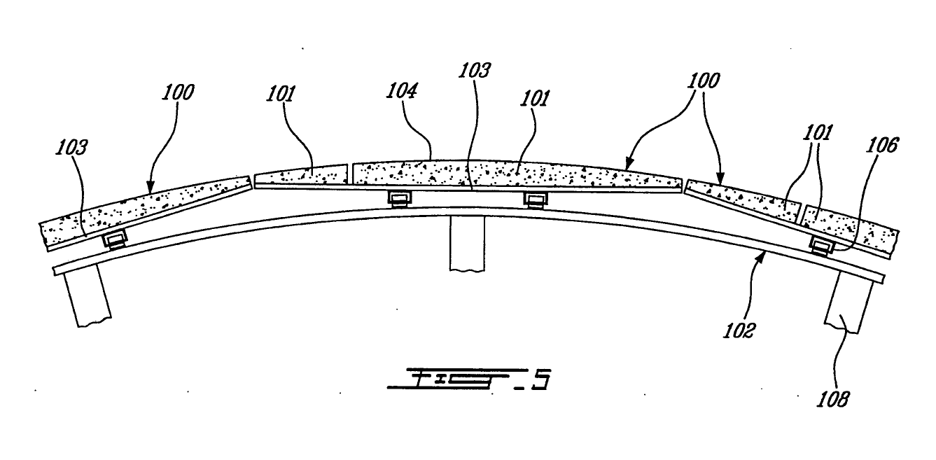

Referring now to FIG. 5, a modular stone panel 100, in accordance with a second illustrative embodiment of the present invention, will be presented. In this embodiment, the modular stone panels 100 are mounted on an arcuate structural wall 102. The panels 100 are fabricated and installed much like the panels 10 of the first illustrative embodiment. However, to provide the appearance of a rounded stone wall, stones or blocks 101 mounted on the backboards 103 of the panels 100 define slightly rounded outer surfaces 104. When mounted side by side on the arcuate wall 102, the rounded outer surfaces 104 of the stones 101 combine to provide the desired effect. It will be apparent to a person of skill in the art that other wall configurations may also be considered by varying, for instance, the curvature of the panel's stone face. Furthermore, the person of skill in the art will understand that the panels 100 may be mounted in a number of ways, namely as illustrated to include mounting brackets 106 as used in the installation of panel 10, but may also be mounted directly to the wall 102, to the structural studs 108 thereof, or using a variety of other methods.

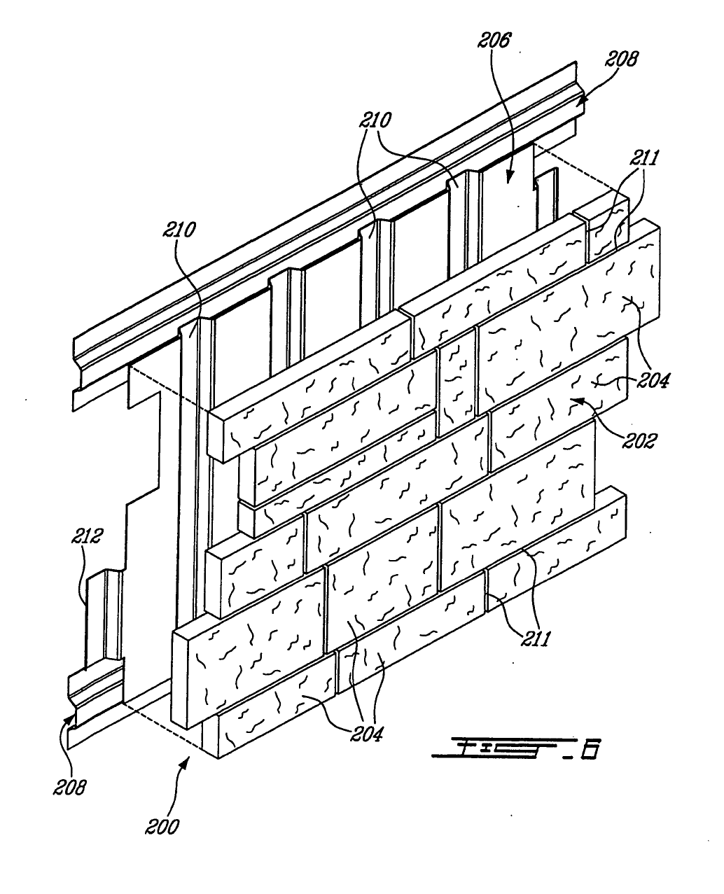

Referring now to FIG. 6, a modular stone panel 200, in accordance with a third illustrative embodiment of the present invention, will be presented. The panel 200 is again generally comprised of a stone face 202, comprising a number of randomly disposed stones or blocks 204, securely mounted on a backboard 206. The panel 200 is then fastened to a solid wall structure or the like (not shown) to provide a desired stone wall finish. In FIG. 6, the panel 200 is fastened directly through backboard 206 to a set of omega-shaped transversal support beams 208 mounted on the structural wall.

Still referring to FIG. 6, the backboard 204 is generally comprised of a single corrugated profile that may be manufactured in a variety of materials such as metals, plastics and the like. In this case, ventilation of the back face of the stones or blocks 204 is provided by the corrugated grooves, as in 210, formed within the backboard 206. A ventilation area may again be varied by varying the width of the grooves 210. As with the panel 10 of FIG. 1, the stones or blocks 204 may be glued directly to the backboard 206 using an appropriate glue or epoxy. Mortar may again be used to fill-in joints 211 between the blocks 204 and ultimately, to conceal joints between adjacent panels 200. Once again, the panel 200 is provided with lateral key-cut 212 edges to reduce the appearance of vertical seams between individual panels 200.

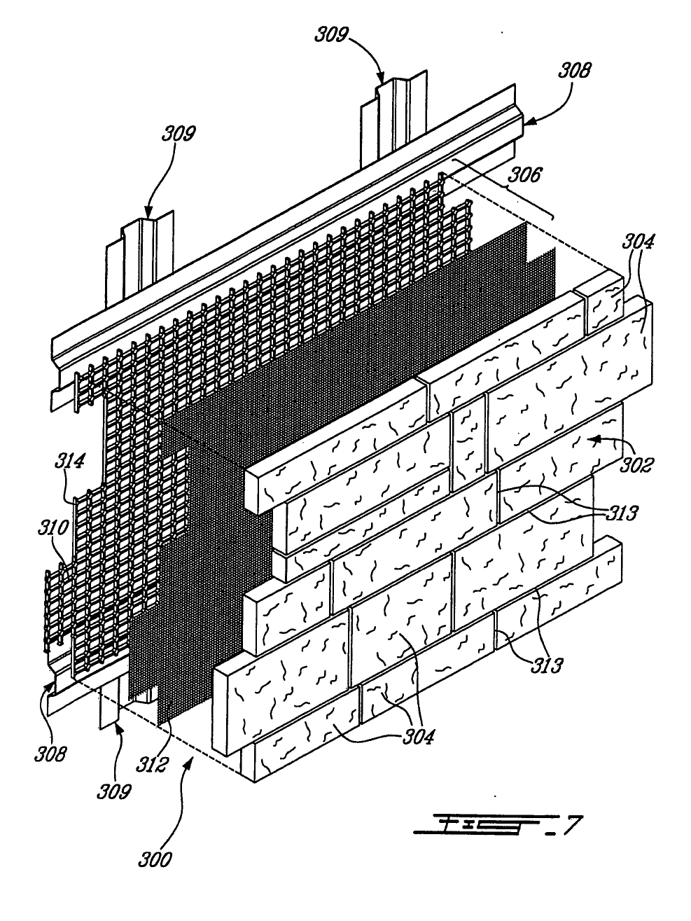

Referring now to FIG. 7, a modular stone panel 300, in accordance with a fourth illustrative embodiment of the present invention, will be described. The panel 300 is again generally comprised of a stone face 302, comprising a number of randomly disposed stones or blocks 304, securely mounted on a backboard 306. The panel 300 is then fastened to a solid wall structure or the like (not shown) to provide a desired stone wall finish. In FIG. 7, the panel 300 is fastened directly through backboard 306 to a set of horizontal omega-shaped transversal support beams 308, which are themselves mounted on the structural wall via a set of inverted vertical omega-shaped support beams 309.

Still referring to FIG. 7, the backboard 304 is generally comprised of a single plastic grating 310 covered by a screen or mesh 312. Illustratively, the plastic grating 310 is manufactured of BX1500 plastic and provides a grid of rectangular openings measuring roughly 1½×1 inches. The screen or mesh 312 is illustratively comprised of a ¼×¼ inch screen and is mounted on the grating 310. In this case, ventilation of the back face of the stones or blocks 304 is provided through the grating 310 and mesh 312 an may again be varied by selecting tighter or looser gratings and/or meshes. As with the panel 10 of FIG. 1, the stones or blocks 304 may be glued directly to the backboard 306 using an appropriate glue or epoxy. Mortar may again be used to fill-in joints 313 between the blocks 304 and ultimately, to conceal joints between adjacent panels 300.

In particular, the mesh 312 provides a greater adhesion surface for the mortar whereas the grating 310 provides greater rigidity to the panel 300 thus enhancing is durability and transportability. However, it was observed that the mesh 312 may also be mounted behind the grating 310 without significantly altering the properties of the panel 300.

Once again, the panel 300 is provided with lateral key-cut edges 314 to reduce the appearance of vertical seams between individual panels 300.

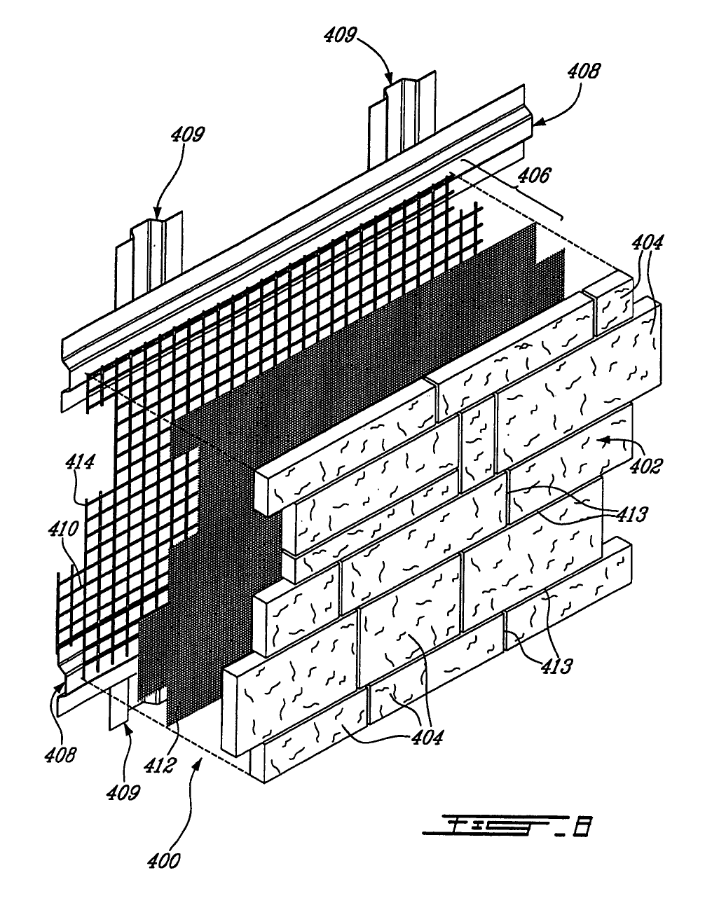

Referring now to FIG. 8, a modular stone panel 400, in accordance with a fifth illustrative embodiment of the present invention, will be described. The panel 400, much like panel 300 of FIG. 7, is again generally comprised of a stone face 402, comprising a number of randomly disposed stones or blocks 404, securely mounted on a backboard 406. The panel 400 is again fastened to a solid wall structure or the like (not shown) to provide a desired stone wall finish, namely fastening the panel 400 directly through backboard 406 to a set of horizontal omega-shaped transversal support beams 408, which are themselves mounted on the structural wall via a set of inverted vertical omega-shaped support beams 409.

Like panel 300, the backboard 404 of panel 400 is generally comprised of a single grating 410 covered by a screen or mesh 412. In this embodiment however, the grating is comprised of a 2×2 inch single metallic grating. Like panel 300 of FIG. 7, ventilation of the back face of the stones or blocks 404 of panel 400 is provided through the grating 410 and mesh 412 an may again be varied by selecting tighter or looser gratings and/or meshes. Again, the stones or blocks 404 may be glued directly to the backboard 406 using an appropriate glue or epoxy. Mortar may again be used to fill-in joints 413 between the blocks 404 and ultimately, to conceal joints between adjacent panels 400.

Again, the mesh 412 is used to provide a greater adhesion surface for the mortar whereas the grating 410 provides greater rigidity to the panel 400 thus enhancing is durability and transportability. The mesh 312 may again be mounted either behind or in front of the grating 310 without significantly altering the properties of the panel 300. Key-cut edges 314 are also provided.

A person of skill in the art will understand that other panel fabrications may be considered without departing from the general scope and nature of the present disclosure. For instance, various combinations of support grids and meshes, as illustrated in FIGS. 7 and 8, may be considered including, but not limited to, various sizes of metallic and plastic grids, various sizes of metallic, plastic, nylon, cotton, and jute screens and meshes, and the like.

Also, various plastic and/or metallic backboards may be considered, each optionally providing ventilation to the stones or blocks mounted thereon using various techniques such as backboard perforations (circular, rectangular, linear, etc.), backboard deformations (corrugation, grooves, channels, etc.) and the like. Materials for these backboards may include, but are not limited to fiber-cements/fiber-reinforced cements (e.g. James Hardie® Building Products' fiber reinforced cement boards, for instance Hardibacker 500®, Hardibacker®, Hardisoffit®, Hardipanel®, Hardiplank®, Harditex®, Sentry®, Harditrim®, Hardishingle™, which include crystalline silica 35-45% by weight, calcium silicate 50-60%, cellulose <10%, other non hazardous ingredients (fillers) <10%; Test Report No. IC-1093A-90) typically asbestos-free and non-combustible, plywood, OSB, shaped, corrugated or perforated sheet metal, steel tubes and bars, concrete, extruded plastics and metals, PVC (3, 4, 6 inch, etc.), Plexiglas®, and the like.

Panels without ventilation may also be considered in certain applications where moisture and humidity concerns are not particularly relevant. In these cases, stones or blocks may be mounted directly on a flat plastic or metallic backboard surface.

Also, one may opt to produce a panel without mortar between the blocks. Namely, blocks could be tightly packed without spaces to provide an alternate visual effect.

In addition, various shapes and sizes of panels may be fabricated depending on the application at hand. For instance, panel widths and heights may be customized according to the selected stone or molded product selected for the project. By varying the width and height of the selected stones, different visual effects may be attained. Also, costs and panel weight may be reduced by selecting thinner stone or molded products without significantly altering the visual and textural finish of the project. For instance, an average stone panel as described hereinabove may weight roughly 10 lb/ft² as opposed to standard stone wall formations weighing roughly 45 lb/ft².

In general, the modular stone panels disclosed herein may be fabricated in a number of ways using a variety of support and finishing materials to customize the finished product in accordance with project requirements and projected costs. Panels may be prefabricated and shipped directly to the construction site for installation. Since the panels are preformed and ready for quick assembly, minimal training and expertise is required to successfully mount the modular panels, unlike traditional stonemasonry.

Although the invention has been described with reference to certain specific embodiments, various modifications thereof will be apparent to those skilled in the art without departing from the spirit and scope of the invention as outlined in the claims appended hereto.

What is claimed is:

1. A modular stone panel for fastening to a wall to provide a stone wall facade therefor, the panel comprising a shaped backboard and a plurality of stones solidly fastened on a front face thereof, said backboard being adapted to be fastened to the wall such that said front face faces away therefrom to provide the stone wall facade.

2. The modular stone panel of claim 1, wherein a number of panels may be adjacently fastened to the wall to provide the stone wall facade.

3. The modular stone panel of claim 2, the panel further comprising key-cut edges such that said adjacently fastened panels may be interlocked along said key-cut edges to conceal a juncture therebetween.

4. The modular stone panel of claim 1, wherein said stones are fastened on said front face leaving joints therebetween, the panel further comprising a mortar to fill-in said joints.

5. The modular stone panel of claim 1, wherein said stones are glued to said backboard.

6. The modular stone panel of claim 1, the panel further comprising at least one mounting bracket fastened on a back face of said backboard to facilitate a fastening thereof to the wall.

7. The modular stone panel of claim 1, wherein said stones are selected from a group comprising at least one of calcareous stones, granite stones, molded concrete blocks, molded cement blocks, molded stone dust blocks and any combination thereof.

8. The modular stone panel of claim 1, wherein said stones are thin natural stones.

9. The modular stone panel of claim 1, wherein said backboard comprises at least one PVC section.

10. The modular stone panel of claim 1, wherein said backboard comprises ventilation means to ventilate said front face such that a back face of said stones is ventilated when said stones are fastened thereto.

11. The modular stone panel of claim 10, wherein said ventilation means comprises a series of ventilation apertures disposed through said backboard.

12. The modular stone panel of claim 10, wherein said backboard comprises a grating, said ventilation means being provided through said grating.

13. The modular stone panel of claim 10, wherein said backboard comprises a shaped backboard, said ventilation means being provided by a profile of said shaped backboard.

14. The modular stone panel of claim 13, wherein said profile is defined by a deformation profile selected from a group comprising at least one of a ventilation groove, a ventilation channel, a ventilation corrugation and any combination thereof.

15. A method of fabricating a modular stone panel, the method comprising the steps of:
a) providing a backboard having a predetermined shape and a plurality of stones; and
b) fastening said stones to said backboard in accordance with said shape;
wherein the backboard is adapted to be fastened to a wall to provide a stone wall facade therefor.

16. The method of claim 15, the method further comprising the step after step b) of applying a mortar between said stones to fill-in a series of joints left therebetween.
